(19) United States
(12) Patent Application Publication
(10) Pub. No.: US 2024/0380273 A1
(43) Pub. Date: Nov. 14, 2024

(54) AXIAL FLUX MACHINE

(71) Applicant: Schaeffler Technologies AG & Co. KG, Herzogenaurach (DE)

(72) Inventors: Ivo AGNER, Buhl (DE); Stefan Riess, Kaufering (DE)

(73) Assignee: Schaeffler Technologies AG & Co. KG, Herzogenaurach (DE)

(21) Appl. No.: 18/688,012

(22) PCT Filed: Sep. 6, 2022
(86) PCT No.: PCT/DE2022/100657

§ 371 Date: Feb. 29, 2024

(30) Foreign Application Priority Data
Sep. 6, 2021 (DE) 10 2021 122 967.7

(51) Int. Cl. H02K 5/20; H02K 9/19; H02K 21/24

(52) U.S. Cl. CPC H02K 5/203; H02K 9/19; H02K 21/24

(57) ABSTRACT

An axial flux machine including a rotor rotatably mounted relative to a stator, the stator having at least one first disc-shaped stator body, and the rotor as well as the first stator body being arranged such that a first magnetically effective gap through which a cooling fluid can flow is formed axially between the first stator body and the rotor. The axial flux machine has at least one first cooling circuit in which the cooling fluid, during operation of the axial flux machine, enters the first gap at a radially inner periphery, flows through the first gap outwardly in the radial direction, and exits the first gap at a radially outer periphery, wherein at least one first cooling channel which can be traversed by the cooling fluid is arranged at the outer periphery of the first gap and guides the cooling fluid back to the radially inner periphery of the first gap.

### CROSS-REFERENCE TO RELATED APPLICATIONS

This application is the U.S. National Phase of PCT Appln. No. PCT/DE2022/100657, filed Sep. 6, 2022, which claims the benefit of German Patent Appln. No. 102021122967.1, filed Sep. 6, 2021, the entire disclosures of which are incorporated by reference herein.

### TECHNICAL FIELD

The present disclosure relates to an axial flux machine, comprising a rotor rotatably mounted relative to a stator, wherein the stator has at least one first disc-shaped stator body and the rotor as well as the first stator body are arranged such that a first magnetically effective gap through which a cooling fluid can flow is formed axially between the first stator body and the rotor.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort they are accustomed to.

A detailed description of an electric drive can be found in an article in the German automotive magazine ATZ, volume 113, May 2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged so as to be concentric and coaxial with a bevel gear differential, wherein a switchable 2-speed planetary gear set is arranged in the drive train between the electric motor and the bevel gear differential and is also positioned to be coaxial with the electric motor or the bevel gear differential or spur gear differential. The drive unit is very compact and allows for a good compromise between climbing ability, acceleration and energy consumption due to the switchable 2-speed planetary gear set. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable—for example in urban areas—a purely electric mode of operation with both sufficient range and availability, in particular when driving cross-country. In addition, there is the possibility of driving the internal combustion engine and the electric motor at the same time in certain operating situations.

An axial flux machine is a dynamo-electric machine in which the magnetic flux between the rotor and stator runs parallel to the rotational axis of the rotor. Often, both the stator and the rotor are designed to be largely disc-shaped. Axial flux machines are particularly advantageous when the axially available installation space is limited in a given application. This is often the case, for example, with the electric drive systems for electric or hybrid vehicles described at the outset.

In addition to the shortened axial installation length, a further advantage of the axial flux machine is its comparatively high torque density. The reason for this is, compared to radial flux machines, the larger air gap area which is available for a given installation space. Furthermore, a lower iron volume is required compared to conventional machines, which has a positive effect on the efficiency of the machine.

Typically, an axial flux machine comprises at least one stator having windings for generating the axially aligned magnetic field. At least one rotor is equipped with permanent magnets, for example, the magnetic field of which interacts with the magnetic field of the stator windings in order to generate a drive torque over an air gap.

### SUMMARY

In the development of electric machines intended for e-axles and hybrid modules, there is a continuing need to increase their power densities, so the cooling of axial flux machines required for this is growing in importance. Owing to the necessary cooling capacities, hydraulic fluids such as cooling oils have become established in most concepts for the removal of heat from the thermally loaded regions of an electric machine. Nevertheless, these cooling strategies are often inadequate and/or involve high technical implementation costs.

It is therefore the object of the disclosure to eliminate or at least mitigate the problems known from the prior art and to provide an axial flux machine with an effective and inexpensive cooling system.

This object is achieved by an axial flux machine, comprising a rotor rotatably mounted relative to a stator, wherein the stator has at least one first disc-shaped stator body and the rotor as well as the first stator body are arranged such that a first magnetically effective gap through which a cooling fluid can flow is formed axially between the first stator body and the rotor, wherein the axial flux machine has at least one first cooling circuit, in which the cooling fluid, during operation of the axial flux machine, enters the first gap at a radially inner periphery, flows through the first gap outwardly in the radial direction, and exits the first gap at a radially outer periphery, wherein at least one first cooling channel through which the cooling fluid can flow is arranged at the outer periphery of the first gap and guides the cooling fluid back to the radially inner periphery of the first gap.

This provides the advantage of improving the cooling of the rotor in particular due to the higher magnetic losses in the rotor at high operating speeds. This in turn makes it possible to increase the continuous power at high speeds and to extend the tolerable load times in higher power ranges.

Due to the differential speed between the rotor and stator, air, for example, is carried along with the rotor and set in rotation. This creates a centrifugal effect in the air, which causes a negative pressure inside the rotor. This effect is used in the disclosure in order to create a cooling circuit, for example with air. In this context, the axial flux machine acts akin to an “air pump” that conveys the cooling fluid through the gap from radially inside to the outside. If it can escape there and be returned to the radially inner periphery of the first gap (rotor inner diameter) by means of a first cooling channel, for example on the stator and/or motor housing in a calmed zone without differential speed of the components, a controlled cooling circuit is created. For example, the surrounding housing parts are generally cooler than the rotor. In this respect, the cooling fluid flows past the cooler housing parts, for example, and can transfer the heat introduced by the rotor to the housing parts, which in turn can dissipate it into the environment.

The individual elements of the claimed subject matter of the disclosure will be explained first, in the order in which they are named in the claims, and then particularly preferred embodiments of the subject matter of the disclosure will be described.

The magnetic flux in an electric axial flux machine (AFM) according to the disclosure is directed axially to a direction of rotation of the rotor of the axial flux machine in the magnetically effective gap between the stator and the rotor. Different types of axial flux machines exist. One known type is what is termed an I arrangement, in which the rotor is arranged so as to be axially adjacent to a stator or between two stators. Another known type is what is termed an H arrangement, in which two rotors are arranged on opposite axial sides of a stator. The axial flux machine according to the disclosure can be designed as an I-type or H-type configuration. In principle, it is also possible for a plurality of rotor-stator configurations to be arranged axially adjacent as an I-type and/or H-type. It would also be possible in this context to arrange both one or more I-type rotor-stator configurations and one or more H-type rotor-stator configurations adjacent to one another in the axial direction. In particular, it is also preferable that the rotor-stator configurations of the H-type and/or the I-type are each designed essentially identically, so that they can be assembled in a modular manner to form an overall configuration. Such rotor-stator configurations can in particular be arranged to be coaxial to one another and can be connected to a common rotor shaft or to a plurality of rotor shafts.

According to a further preferred further development of the disclosure, the stator can, in particular, also comprise at least one second disc-shaped stator body, which is arranged coaxially to the first stator body and to the rotor shaft with axial interposition of one of the rotor bodies spaced apart from the first stator body, so that an I-type configuration of an axial flux machine is implemented.

A rotor can also have a rotor shaft. A rotor shaft is a rotatably mounted shaft of an electric machine to which the rotor or rotor body is coupled in a non-rotatable manner.

In this context, it is particularly preferable for the rotor to have a rotor shaft with at least one first disc-shaped rotor body, which is arranged on the rotor shaft in a non-rotatable manner, which enables cost-efficient production by dividing the rotor into magnetically effective components (rotor body) and purely mechanical components (rotor shaft). In particular, this also makes it possible to design the various previously mentioned I-type and/or H-type configurations in a particularly flexible manner.

The rotor of an electric axial flux machine can preferably be designed at least in parts as a laminated rotor. A laminated rotor is designed to be layered in the axial direction. Alternatively, the rotor of an axial flux machine can also have a rotor carrier or rotor body which is correspondingly equipped with magnetic sheets and/or SMC material and with magnetic elements designed as permanent magnets.

A rotor can comprise a rotor body. In a preferred manner, a rotor body has an inner part via which the rotor can be connected to a shaft in a non-rotatable manner, and an outer part which delimits the rotor in a radially outward direction. The rotor body can be formed between the inner part and the outer part with several rotor struts, via which the inner part and the outer part are connected to one another and which, together with the radial outer surface of the inner part and the radial inner surface of the outer part, forms a receiving space for accommodating the magnetic elements and the flux conducting elements of the rotor. As an alternative to the receiving space, the magnetic elements can be arranged or placed on the rotor carrier.

A magnetic element can be formed as a permanent magnet in the form of a bar magnet or in the form of smaller magnet blocks. The magnetic elements are usually arranged in, at or on a rotor carrier. The magnetic element of a rotor of an axial flux machine, which is designed as a permanent magnet, interacts with a rotating magnetic field generated by the stator winding coils, which are usually supplied with a three-phase current.

The stator of an electric axial flux machine preferably has a stator body with a plurality of stator windings arranged in the circumferential direction. The stator body can be designed to be in one piece or segmented, as seen in the circumferential direction. The stator body can be formed from a laminated stator core with multiple laminated electrical sheets. Alternatively, the stator body can also be formed from a compressed soft magnetic material, such as what is termed an SMC (soft magnetic composite) material.

The axial flux machine can have a motor housing. The motor housing encloses the axial flux machine at least in sections, preferably completely. A motor housing can also accommodate the control and power electronics. The motor housing can furthermore be part of a cooling system for the electric machine, and can be designed in such a way that cooling fluid can be supplied to the axial flux machine via the motor housing and/or the heat can be dissipated to the outside via the housing surfaces.

A motor housing can be formed in particular from a metallic material. Advantageously, the motor housing can be formed from a cast metal material, such as gray cast iron or cast steel. In principle, it is also conceivable to form the motor housing entirely or partially from a plastic. It is particularly preferable for the motor housing to have the basic shape of a cylindrical ring. The motor housing can be designed in one piece or multiple pieces. It can also be advantageous for one or more stator carriers to be formed in one piece with the motor housing, at least in sections, which can further improve the ease of assembly of the axial flux machine.

According to an advantageous embodiment of the disclosure, a first disc-shaped stator body and/or a second disc-shaped stator body can be designed as a circuit board, in particular as a printed circuit board, which is also referred to as a PCB, as a result of which the stator body can be manufactured in a particularly compact and cost-effective manner. In this regard, the winding of the stator body is formed in one piece with the circuit board. The circuit board is preferably a multi-layer board with multiple copper layers over which the stator windings extend. A further possible embodiment is to design the stator body as a sandwich of several multi-layer boards. The circuit board is preferably made of a composite of epoxy resin and glass fiber.

The axial flux machine is intended in particular for use within an electrically operable drive train of a motor vehicle. In particular, the axial flux machine is dimensioned such that vehicle speeds of more than 50 km/h, preferably more than 80 km/h and in particular more than 100 km/h can be achieved. The axial flux machine particularly preferably has an output of more than 30 KW, preferably more than 50 KW and in particular more than 70 KW. Furthermore, it is preferred that the axial flux machine provides speeds greater than 5,000 rpm, particularly preferably greater than 10,000 rpm, very particularly preferably greater than 12,500 rpm.

Furthermore, according to an equally advantageous embodiment of the disclosure, the axial flux machine can have at least one second cooling circuit, in which the cooling fluid, during operation of the axial flux machine, enters a second gap at a radially inner periphery between a stator body and the rotor or a second gap between a motor housing and the rotor, flows through the second gap outwardly in the radial direction, and exits the second gap at a radially outer periphery, wherein the first cooling channel and/or at least one second cooling channel through which the cooling fluid can flow is arranged at the outer periphery of the second gap and guides the cooling fluid back to the radially inner periphery of the second gap.

In particular, the second gap can also be a magnetically effective gap, which is defined by a rotor and a stator adjacent to the rotor.

According to a further particularly preferred embodiment of the disclosure, the first stator body and/or the second stator body can be accommodated in a stator carrier, which simplifies the assembly of the stator carriers in the axial flux machine.

Furthermore, the disclosure can also be further developed in such a way that the stator is surrounded by the motor housing at least in sections, wherein the first cooling channel and/or the second cooling channel is formed at least in sections between the motor housing and the stator, and/or wherein the first cooling channel and/or the second cooling channel is formed at least in sections in the motor housing, and/or the first cooling channel or the second cooling channel is formed at least in sections in or on one of the stator bodies and/or one of the stator carriers.

In an equally preferred embodiment of the disclosure, the first cooling channel and/or the second cooling channel can have, in the region of the outer periphery of one of the gaps, a first cooling channel section open in the radial direction towards the gap.

In particular, the first cooling channel section can extend in the radial direction. Particularly preferably, the first cooling channel section extends in the radial direction through the stator carrier. In principle, however, it is also conceivable that the first cooling channel section is guided axially through the stator carrier, at least in sections, and particularly preferably exits the stator carrier at an axial end face. To this end, the first cooling channel section can have an L-shaped axial section contour, for example. It can also be advantageous to further develop the disclosure in such a way that the first cooling channel section has, at least in sections, a channel section associated with the first gap and a channel section associated with the second gap, thereby allowing for a targeted, gap-specific guidance of the cooling fluid through the first cooling channel section.

According to a further preferred embodiment of the subject matter of the disclosure, the first cooling channel and/or the second cooling channel can each have a second cooling channel section extending in the axial direction, which connects the first cooling channel section to a third cooling channel section extending in the radial direction. In this context, the disclosure can also be advantageously designed in such a way that the stator carrier and/or a rotor shaft of the rotor has/have at least one fourth cooling channel section extending in the axial direction, which connects the radially inner periphery of one of the gaps to the third cooling channel section.

In order to ensure pressure equalization between the first and the second gap at the inner periphery of the rotor, the rotor shaft can preferably have a fifth cooling channel section extending in the axial direction through the rotor shaft, which connects the gaps to one another in a communicating manner.

Furthermore, it is particularly preferred that a means for controlling the flow rate of cooling fluid is arranged in the first cooling channel and/or the second cooling channel. The control of the flow rate of cooling fluid can most preferably be implemented in a speed-dependent and/or pressure-dependent and/or centrifugal force-dependent and/or temperature-dependent manner.

The control of the flow rate of cooling fluid is particularly preferably designed such that a circulation of cooling fluid through one of the cooling channels is enabled in the field weakening region of the axial flux machine, while a circulation of cooling fluid through one of the cooling channels outside of the field weakening region of the axial flux machine is at least reduced and preferably prevented. At low speeds of the axial flux machine in the partial load range, the friction losses in the magnetically effective gap are, in this manner, kept low for efficiency reasons and a circulation of cooling fluid is generally prevented. At higher speeds, on the other hand, the gap losses in the magnetically effective gap play only a minor role for efficiency reasons, as the effect of heat dissipation and the robustness of the system are more important here.

The means for controlling the flow rate of cooling fluid can preferably be selected from the group of pressure-dependent switching elements, in particular from the group of valves, most preferably check valves, centrifugal force-based and/or speed-dependent switching elements, in particular leaf springs, and/or temperature-based switching elements, in particular bimetallic elements.

It has proven to be particularly advantageous that the first cooling channel section has means for controlling the flow rate of cooling fluid through the first cooling channel section. It may also be additionally or alternatively preferable that a means for controlling the flow rate of cooling fluid is arranged in the cooling fluid path between the radially inner periphery of one of the gaps and the third cooling channel section.

The cooling fluid is advantageously gaseous. In particular, the cooling fluid is preferably selected from a group comprising air, nitrogen and nitrogen-containing gas mixtures, noble gases and noble gas-containing gas mixtures.

### BRIEF DESCRIPTION OF THE DRAWINGS

The disclosure is explained in more detail below with reference to drawings without limiting the general concept of the disclosure.

In the drawings:

FIG. 1 shows a first embodiment of an axial flux machine in a first axial sectional view,

FIG. 2 shows a first embodiment of an axial flux machine in a second axial sectional view,

FIG. 3 shows a second embodiment of an axial flux machine in an axial sectional view,

FIG. 4 shows a third embodiment of an axial flux machine in an axial sectional view,

FIG. 5 shows a fourth embodiment of an axial flux machine in an axial sectional view,

FIG. 6 shows a fifth embodiment of an axial flux machine in an axial sectional view,

FIG. 7 shows a sixth embodiment of an axial flux machine in an axial sectional view,

FIG. 8 shows a seventh embodiment of an axial flux machine in an axial sectional view,

FIG. 9 shows an eighth embodiment of an axial flux machine in an axial sectional view,

FIG. 10 shows a ninth embodiment of an axial flux machine in an axial sectional view,

FIG. 11 shows a tenth embodiment of an axial flux machine in an axial sectional view,

FIG. 12 shows an eleventh embodiment of an axial flux machine in an axial sectional view,

FIG. 13 shows a twelfth embodiment of an axial flux machine in an axial sectional view.

### DETAILED DESCRIPTION

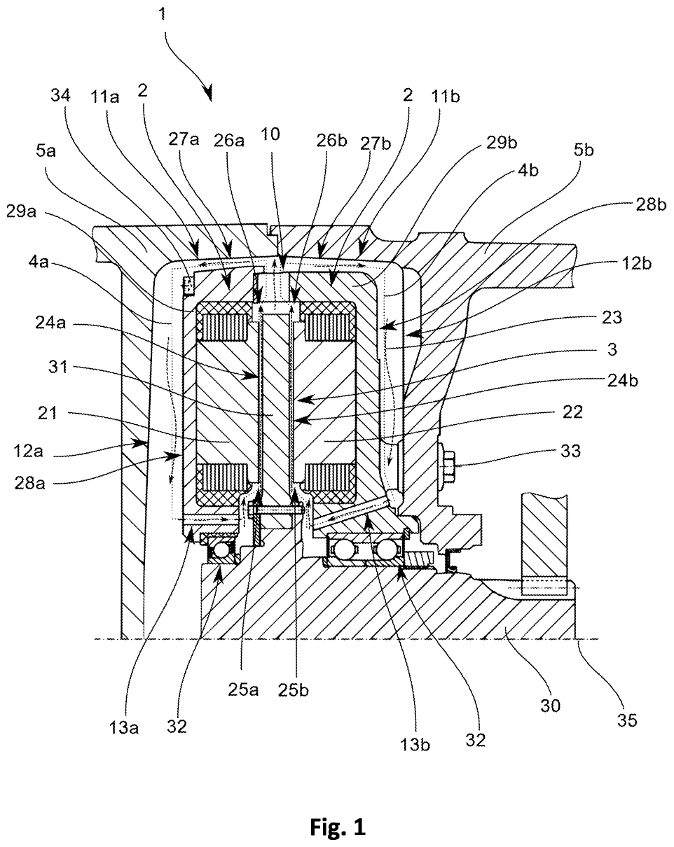

FIG. 1 shows a first embodiment of an axial flux machine 1, comprising a rotor 3 rotatably mounted relative to a stator 2, wherein the stator 2 has at least one first disc-shaped stator body 21 and the rotor 3 as well as the first stator body 21 are arranged such that a first magnetically effective gap 24a through which a cooling fluid 23 can flow is formed axially between the first stator body 21 and the rotor 3. The rotor 3, which rotates about the rotational axis 35, has a rotor shaft 30 with a first disc-shaped rotor body 31 arranged on the rotor shaft 30 in a non-rotatable manner, which defines the magnetically effective first gap 24a with the first stator body 21.

The axial flux machine 1 has a first cooling circuit 4a, in which the cooling fluid 23, during operation of the axial flux machine 1, enters the first gap 24a at a radially inner periphery 25a, flows through the first gap 24a outwardly in the radial direction, and exits the first gap 24a at a radially outer periphery 26a. In this context, the cooling fluid 23 guided through the first gap 24a dissipates heat from the gap 24a. A first cooling channel 27a through which the cooling fluid 23 can flow is arranged at the outer periphery 26a of the first gap 24a and guides the cooling fluid 23 back to the radially inner periphery 25a of the first gap 24a. Here, the heated cooling fluid 23 cools down on the upright walls of the colder motor housing 5 and the stator carrier 29 before it re-enters the first gap 24a.

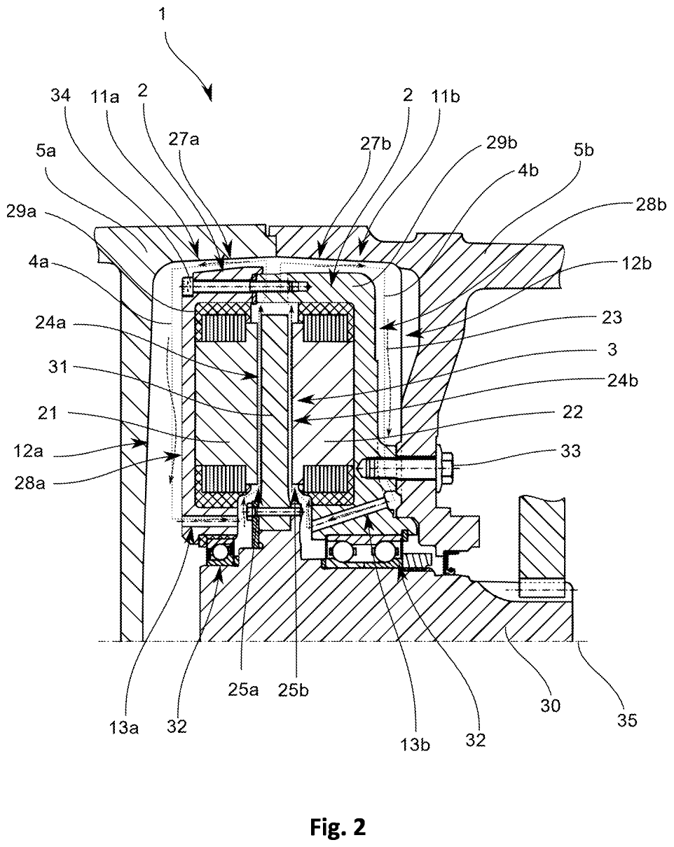

The stator 2 of the embodiment shown has a second disc-shaped stator body 22, which is arranged coaxially to the first stator body 21 and to the rotor shaft 30 with axial interposition of the rotor body 31 spaced apart from the first stator body 21. FIG. 1 thus shows an axial flux machine 1 in an I-type configuration. The first stator body 21 and the second stator body 22 are each accommodated in a stator carrier 29a, 29b, which are fixed against one another by means of the screw 34 and are jointly connected to the motor housing 5b via the screw 33, as can be seen from the axial sectional view in FIG. 2. The stator carriers 29a, 29b are mounted relative to the rotating rotor shaft 30 via the rolling bearings 32.

The axial flux machine 1 further has a second cooling circuit 4b, in which the cooling fluid 23, during operation of the axial flux machine 1, enters a second gap 24b at a radially inner periphery 25b between the second stator body 2 and the rotor 3, flows through the second gap 24b outwardly in a radial direction and exits the second gap 24b at a radially outer periphery 26b. A second cooling channel 27b through which the cooling fluid 23 can flow is arranged at the outer periphery 26b of the second gap 24b and guides the cooling fluid 23 back to the radially inner periphery 25b of the second gap 24b.

FIG. 1 also shows that the stator 2 is completely surrounded by the motor housing 5a, 5b, wherein the first cooling channel 27a and the second cooling channel 27b are each formed between the motor housing 5a, 5b and the stator 2 or the stator carriers 29a, 29b.

The first cooling channel 27a and the second cooling channel 27b have, in the region of the outer periphery 26a, 26b of one of the gaps 24a, 24b, a common first cooling channel section 10 open in the radial direction towards the gap 24a, 24b.

The first cooling channel 27a and the second cooling channel 27b each have a second cooling channel section 11a, 11b extending in the axial direction, which connects the first cooling channel section 10 to a third cooling channel section 12a, 12b extending in the radial direction. The stator carriers 29a, 29b each have a fourth cooling channel section 13a, 13b extending in the axial direction, which connects the radially inner periphery 25 of the gaps 24a, 24b to the third cooling channel section 12a, 12b in each case.

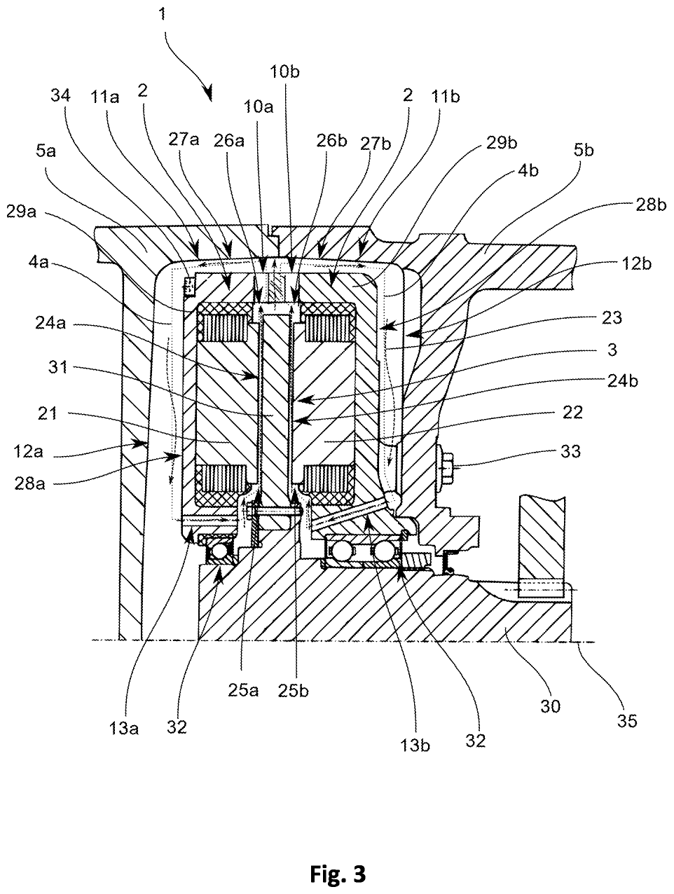

As shown in the embodiment of FIG. 3, the first cooling channel section 10 can have, at least in sections, a channel section 10a associated with the first gap 24a and a channel section 24b associated with the second gap 24b, whereby an improved separate guidance of the cooling fluid 23 from the gaps 24a, 24b can be implemented.

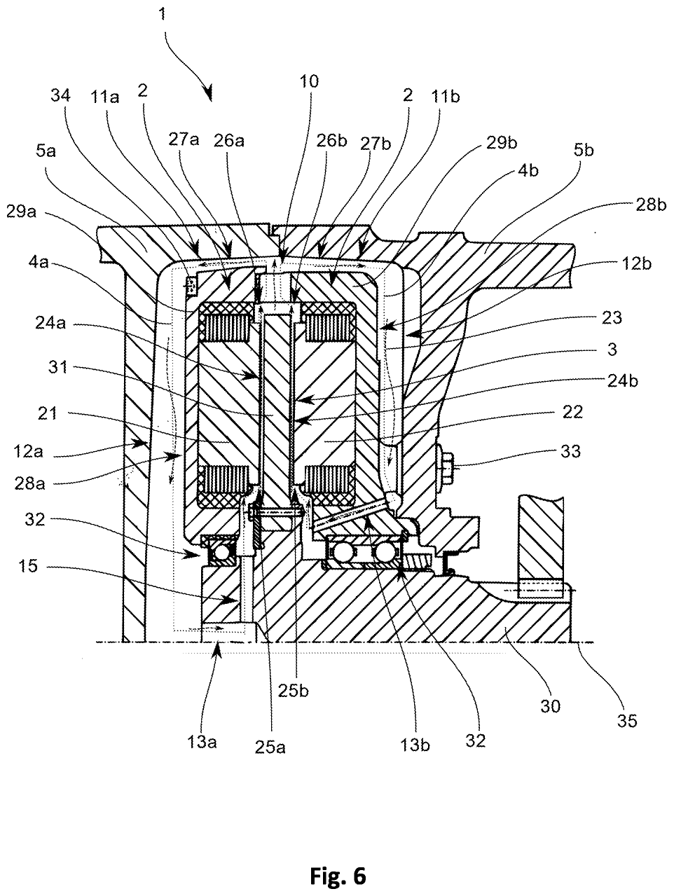

FIG. 6 shows an embodiment of the axial flux machine 1 in which the rotor shaft 30 of the rotor 3 has a fourth cooling channel section 13a extending in the axial direction, which connects the radially inner periphery 25 of the first gap 24a to the third cooling channel section 12a with the interposition of a radially extending sixth cooling channel section 15. Due to this, the radial path of the cooling fluid 23 in the radially extending third cooling channel section 12a can be extended, which contributes to correspondingly improved cooling.

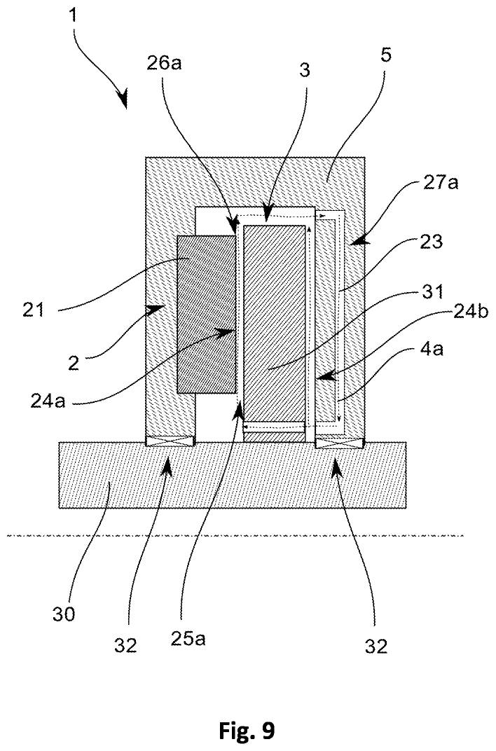

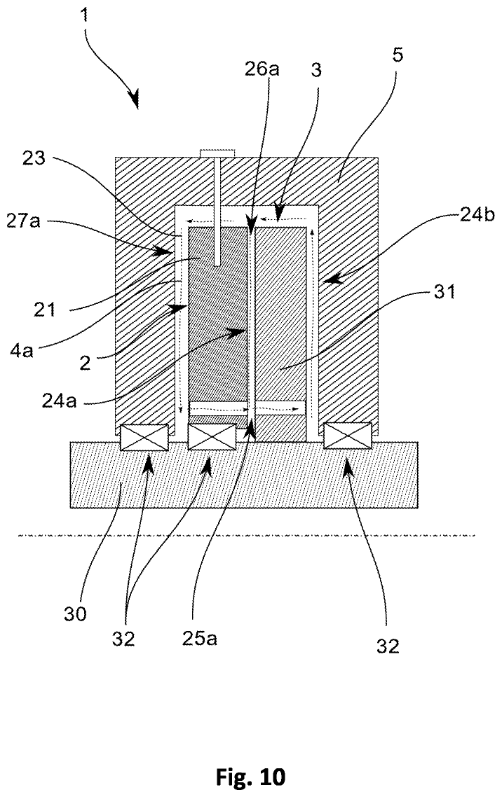

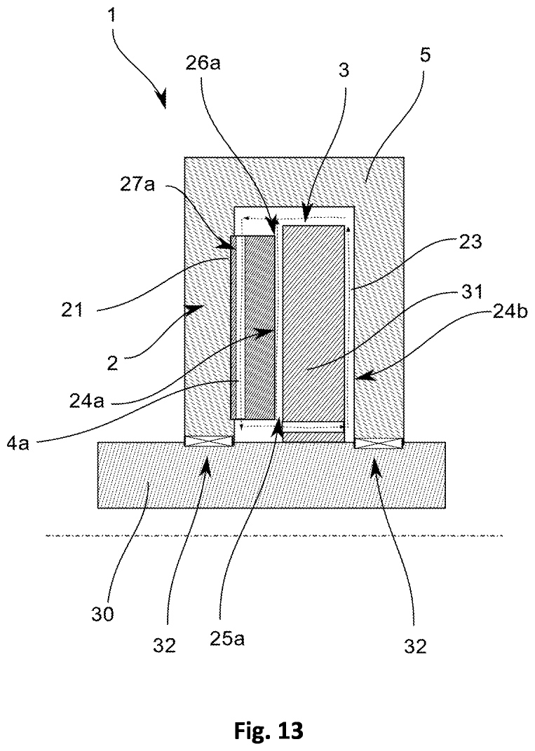

FIG. 13 shows a further modification of the axial flux machines 1 known from FIGS. 9-10, in which the first cooling channel 27a also runs in sections in the stator body 21. Of course, it would also be possible to pass the first cooling channel 27a at least in sections through a stator carrier 29a, 29b as known from FIGS. 1-8.

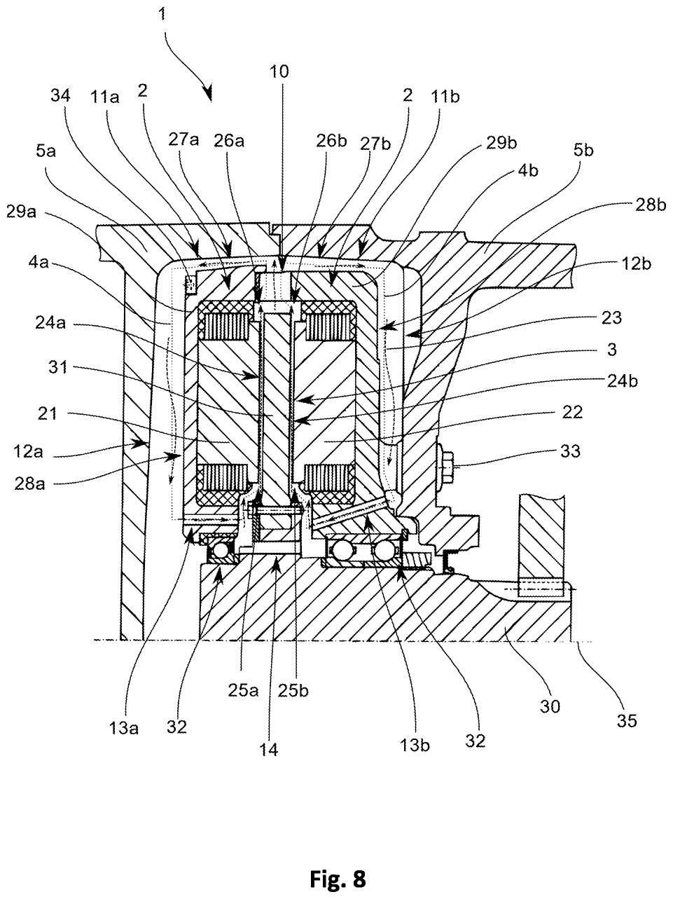

As shown in the embodiment of FIG. 8, in order to equalize the pressure between the two axial sides of the rotor 3, the rotor shaft 30 can have a fifth cooling channel section 14 extending in the axial direction through the rotor shaft 30, which connects the gaps 24a, 24b to one another in a communicating manner.

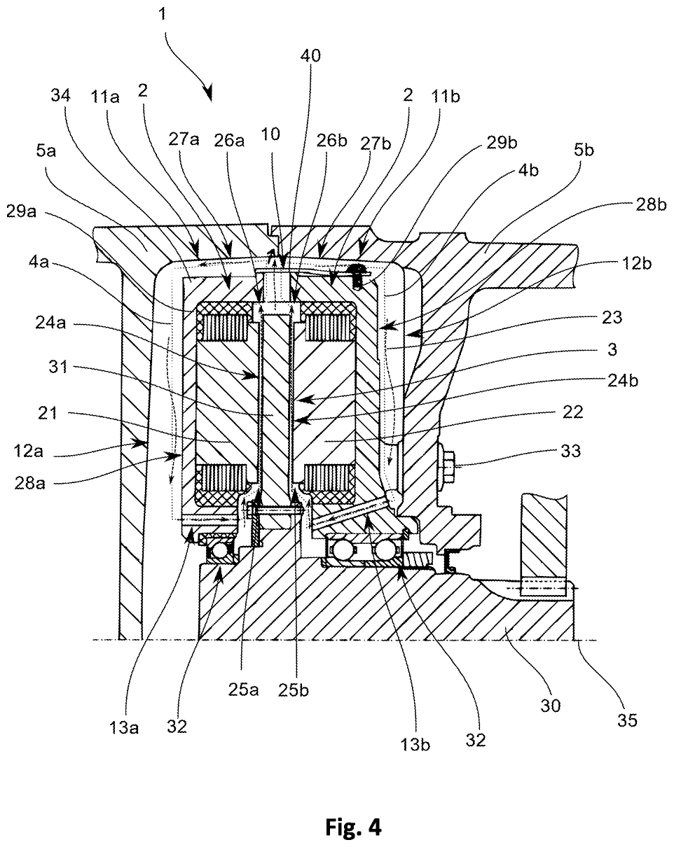

In each of the embodiments of FIGS. 4, 5 and 7, an embodiment of an axial flux machine 1 is shown in which at least one means for controlling 40 the flow rate of cooling fluid 23 is arranged in the first cooling channel 27a and/or the second cooling channel 27b. The control of the flow rate of cooling fluid 23 can, in particular, be implemented in a speed-dependent and/or pressure-dependent and/or centrifugal force-dependent and/or temperature-dependent manner. The control of the flow rate of cooling fluid 23 can, in particular, be designed such that a circulation of cooling fluid 23 through one of the cooling channels 27a, 27b is enabled in the field weakening region of the axial flux machine 1, while a circulation of cooling fluid 23 through one of the cooling channels 27a, 27b outside of the field weakening region of the axial flux machine 1 is at least reduced and preferably prevented.

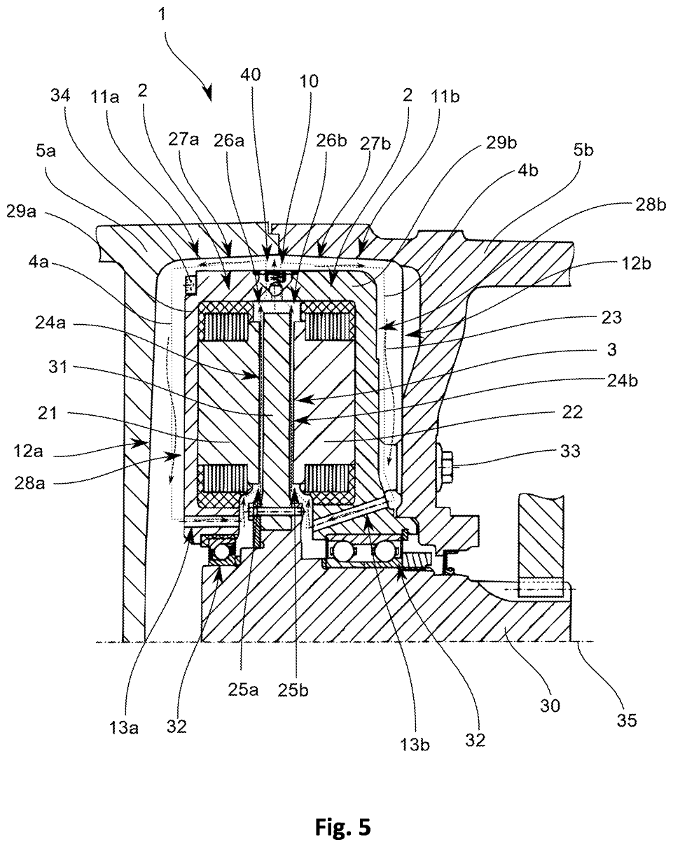

In this context, FIG. 5 shows a possible embodiment in which a means for controlling 40 the flow rate of cooling fluid 23 through the first cooling channel section 10 is arranged in the first cooling channel section 10. This means is designed as a ball valve spring-loaded against the direction of flow of the cooling fluid 23, which opens automatically at a predefined pressure on the inlet side of the first cooling channel section 10 and releases the flow cross-section of the first cooling channel section 10.

As an alternative to the ball valve known from FIG. 5, FIG. 4 shows a means for controlling 40 the flow rate of cooling fluid 23 that is designed as a diaphragm spring valve. It essentially consists of a leaf spring attached to the radially outer jacket of the stator carrier 29 by means of a screw, which seals the first cooling channel section 10 in an abutting manner under a spring preload.

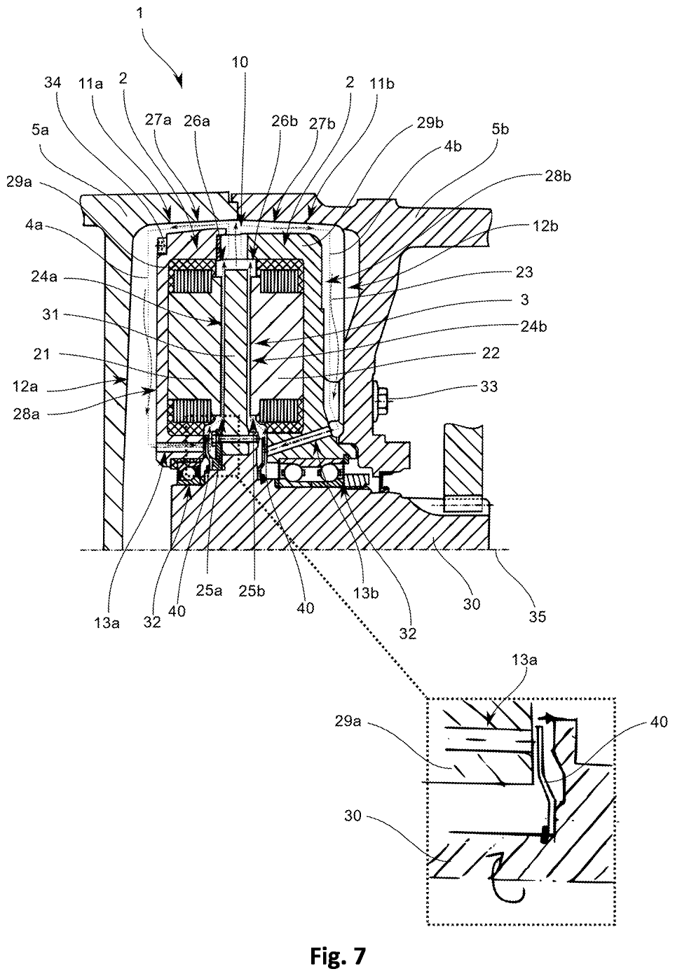

FIG. 7 shows another alternative. Here, a means for controlling 40 the flow rate of cooling fluid 23 is arranged in the cooling fluid path between the radially inner periphery 25 of the first gap 24a and the fourth cooling channel section 13a, which is designed as a spring element fixed to the rotor shaft 30 on one side in a non-rotatable manner, which covers the flow cross-section of the fourth cooling channel section 13a at low speeds and releases the flow cross-section of the fourth cooling channel section 13a at higher speeds due to the centrifugal force acting on the spring element. An essentially functionally identical spring element is also located at the fourth cooling channel section 13b of the second cooling channel 27b.

FIG. 9 shows a design of the axial flux machine 1 consisting only of a first stator 2 and a first rotor 3 with a rotor body 31. In this regard, the first cooling circuit 4a is designed in such a way that the first cooling channel 27a is formed in the motor housing 5. Furthermore, the axial flux machine 1 shown also has a second gap 24b between the motor housing and the rotor 3, wherein this second gap 24b is not magnetically effective. Nevertheless, the first rotor body 31 can be cooled by the cooling fluid 23 circulating in the second gap 24b in an effective manner due to cooling from two sides. In order to close the cooling circuit 4a at the radially inner periphery 25a, the rotor body 31 has a channel (not further specified) extending through the rotor body 31 in the axial direction.

FIG. 10 shows an axial flux machine 1, which also only consists of a rotor 3 and a stator 2 positioned in the housing 5 in a non-rotatable manner via a screw connection. Here, however, the cooling fluid 23 is returned via the rear of the stator 2 back to the radially inner periphery 25a of the first gap 24a, so that no channels or holes in the motor housing 5 are required here. Here too, as already shown in FIG. 9, the cooling fluid 23 flows axially over both sides of the rotor.

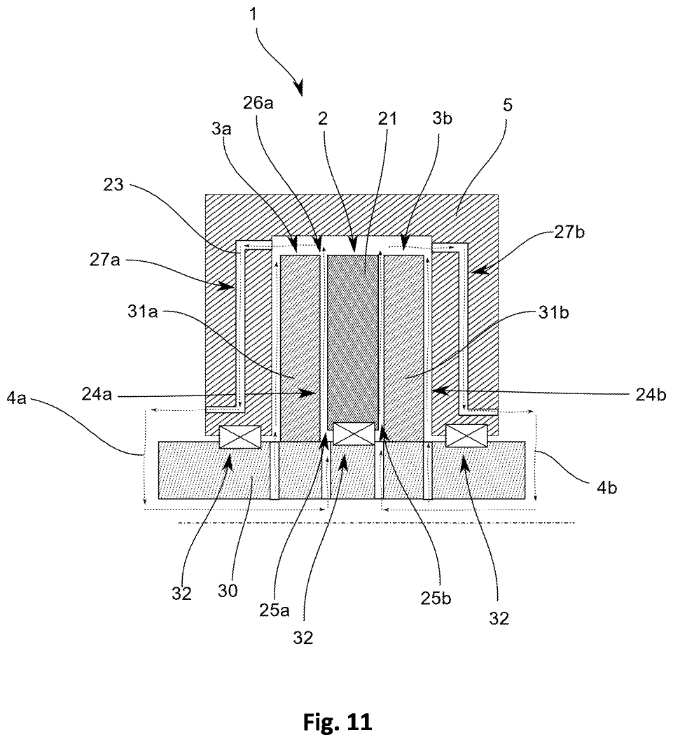

An axial flux machine 1 in an H-type configuration is sketched in FIG. 11. Here, a stator 2 arranged in a non-rotatable manner relative to the housing 5 with a stator body 21 is arranged axially on both sides of a rotor body 31a, 31b in each case. The axial flux machine 1 has a first cooling circuit 4a and a second cooling circuit 4b. The first cooling channel 27a and the second cooling channel 27b extend in sections in the motor housing 5a, 5b and the cooling circuits 4a, 4b are closed by bores extending radially through the rotor shaft 30.

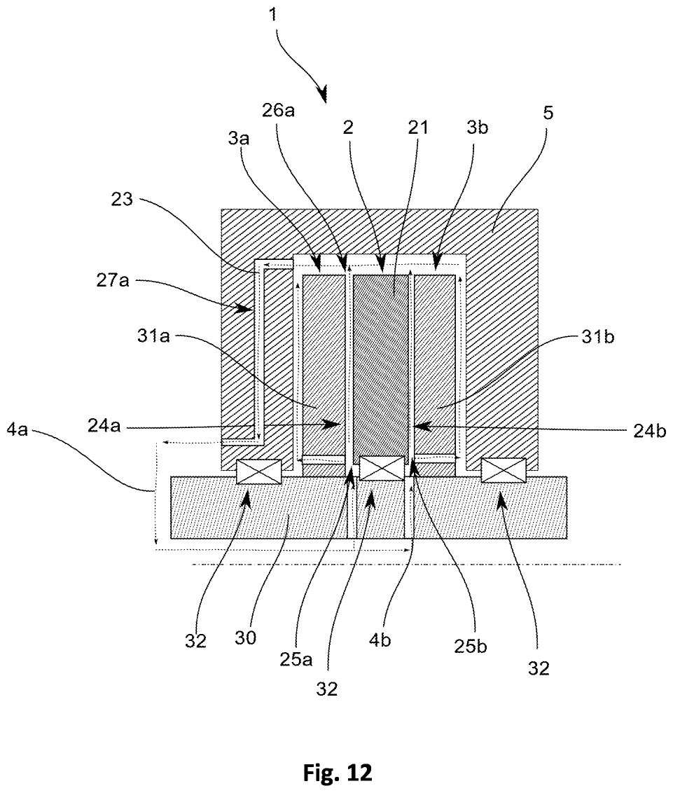

FIG. 12 shows a modified form of the axial flux machine 1 known from FIG. 11 with only one cooling circuit 4a, which, however, is guided through the first gap 24a and the second gap 24b.

It is to be understood that the features of the various embodiments can also be freely combined with one another. The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Axial flux machine
2 Stator
3 Rotor
4 Cooling circuit
5 Motor housing
10 Cooling channel section
11 Cooling channel section
12 Cooling channel section
13 Cooling channel section
14 Cooling channel section
15 Cooling channel section
21 Stator body
22 Stator body
23 Cooling fluid
24 Gap
25 Periphery
26 Periphery
27 Cooling channel
29 Stator carrier
30 Rotor shaft
31 Rotor body
32 Rolling bearing
33 Screw
34 Screw
35 Rotational axis
40 Means for controlling the flow rate of cooling fluid

1. An axial flux machine, comprising: a rotor rotatably mounted relative to a stator, wherein the stator has at least one first disc-shaped stator body and the rotor as well as the first stator body are arranged such that a first magnetically effective gap through which a cooling fluid can flow is formed axially between the first stator body and the rotor,
wherein
the axial flux machine has at least one first cooling circuit, in which the cooling fluid, during operation of the axial flux machine, enters the first gap at a radially inner periphery, flows through the first gap outwardly in a radial direction, and exits the first gap at a radially outer periphery, wherein at least one first cooling channel through which the cooling fluid can flow is arranged at the outer periphery of the first gap and guides the cooling fluid back to the radially inner periphery of the first gap.

2. The axial flux machine according to claim 1,
wherein
the rotor has a rotor shaft with at least one first disc-shaped rotor body arranged on the rotor shaft in a non-rotatable manner.

3. The axial flux machine according to claim 2, wherein
the stator comprises at least one second disc-shaped stator body, which is arranged coaxially to the first stator body and to the rotor shaft with axial interposition of one of the rotor bodies spaced apart from the first stator body.

4. The axial flux machine according to claim 3, wherein
the axial flux machine has at least one second cooling circuit, in which the cooling fluid, during operation of the axial flux machine, enters a second gap at a radially inner periphery between a stator body and the rotor or a second gap between a motor housing and the rotor, flows through the second gap outwardly in a radial direction, and exits the second gap at a radially outer periphery, wherein at least one of the first cooling channel or at least one second cooling channel through which the cooling fluid can flow is arranged at the outer periphery of the second gap and guides the cooling fluid back to the radially inner periphery of the second gap.

5. The axial flux machine according to claim 4, wherein
at least one of the first stator body or the second stator body is accommodated in a stator carrier.

6. The axial flux machine according to claim 5, wherein
the stator is surrounded by the motor housing at least in sections, wherein at least one of: the first cooling channel or the at least one second cooling channel is formed at least in sections between the motor housing and the stator; or the first cooling channel or the second cooling channel is formed at least in sections in the motor housing; or the first cooling channel or the second cooling channel is formed at least in sections in or on one of the stator bodies or the stator carrier.

7. The axial flux machine according to claim 6, wherein
at least one of the first cooling channel or the second cooling channel has, in a region of the outer periphery of one of the gaps, a first cooling channel section open in the radial direction towards the gap.

8. The axial flux machine according to claim 7,
wherein
the first cooling channel section has, at least in sections, a channel section associated with the first gap and a channel section associated with the second gap.

9. The axial flux machine according to claim 8, wherein
at least one of the first cooling channel and/or the second cooling channel has a second cooling channel section extending in the axial direction, which connects the first cooling channel section to a third cooling channel section extending in the radial direction.

10. The axial flux machine according to claim 9,
wherein
at least one of the stator carrier the rotor shaft of the rotor has at least one fourth cooling channel section extending in the axial direction, which connects the radially inner periphery of one of the gaps to the third cooling channel section.

11. The axial flux machine according claim 10, wherein
the rotor shaft has a fifth cooling channel section extending in the axial direction through the rotor shaft, which connects the gaps to one another in a communicating manner.

12. The axial flux machine according claim 4, wherein
at least one means for controlling a flow rate of cooling fluid is arranged in the first cooling channel and/or the second cooling channel.

13. The axial flux machine according to claim 12,
wherein
the control of the flow rate of cooling fluid is implemented in at least one of a speed-dependent, pressure-dependent, centrifugal force-dependent or temperature-dependent manner.

14. The axial flux machine according to claim 13,
wherein
the control of the flow rate of cooling fluid is designed such that a circulation of cooling fluid through one of the first or second cooling channels is enabled in a field weakening region of the axial flux machine, while a circulation of cooling fluid through one of the first or second cooling channels outside of the field weakening region of the axial flux machine is at least reduced.

15. A method of cooling an axial flux machine comprising:
providing an axial flux machine, the axial flux machine including:
a rotor rotatably mounted relative to a stator, wherein the stator has at least one first disc-shaped stator body and the rotor as well as the first stator body are arranged such that a first magnetically effective gap through which a cooling fluid can flow is formed axially between the first stator body and the rotor, wherein the axial flux machine has at least one first cooling circuit, in which the cooling fluid, during operation of the axial flux machine, enters the first gap at a radially inner periphery, flows through the first gap outwardly in a radial direction, and exits the first gap at a radially outer periphery, wherein at least one first cooling channel through which the cooling fluid can flow is arranged at the outer periphery of the first gap and guides the cooling fluid back to the radially inner periphery of the first gap, wherein the rotor has a rotor shaft with at least one first disc-shaped rotor body arranged on the rotor shaft in a non-rotatable manner, wherein the stator comprises at least one second disc-shaped stator body, which is arranged coaxially to the first stator body and to the rotor shaft with axial interposition of one of the rotor bodies spaced apart from the first stator body, and wherein the axial flux machine has at least one second cooling circuit, in which the cooling fluid, during operation of the axial flux machine, enters a second gap at a radially inner periphery between a stator body and the rotor or a second gap between a motor housing and the rotor, flows through the second gap outwardly in a radial direction, and exits the second gap at a radially outer periphery, wherein at least one of the first cooling channel or at least one second cooling channel through which the cooling fluid can flow is arranged at the outer periphery of the second gap and guides the cooling fluid back to the radially inner periphery of the second gap;
and
controlling the flow rate of cooling fluid in at least one of a speed-dependent, pressure-dependent, centrifugal force-dependent or temperature-dependent manner.

16. The method according to claim 15, wherein controlling the flow rate of cooling fluid is configured such that a circulation of cooling fluid through one of the first or second cooling channels is enabled in a field weakening region of the axial flux machine, while a circulation of cooling fluid through one of the first or second cooling channels outside of the field weakening region of the axial flux machine is at least reduced.
